(19) United States
(12) Patent Application Publication
(10) Pub. No.: US 2025/0138878 A1
(43) Pub. Date: May 1, 2025

(54) APPARATUS, METHOD, AND SYSTEM FOR PRIORITIZING A PLURALITY OF APPLICATIONS BASED ON MEMORY BANDWIDTH UTILIZATION

(71) Applicant: Intel Corporation, Santa Clara, CA (US)

(72) Inventors: Aaron MCGAVOCK, Orangevale, CA (US); Venkatesh RAMANI, Milpitas, CA (US)

(21) Appl. No.: 18/619,379

(22) Filed: Mar. 28, 2024

(51) Int. Cl. G06F 9/48; G06F 9/50; G06F 11/30

(52) U.S. Cl. CPC G06F 9/4881; G06F 9/5027; G06F 11/302; G06F 2209/5021; G06F 2209/5022

(57) ABSTRACT

An apparatus, computer-implemented method, and system for prioritizing a plurality of applications based on memory bandwidth utilization. The apparatus includes memory circuitry, machine-readable instructions, and processor circuitry to determine a bandwidth threshold based on the plurality of applications, wherein the bandwidth threshold is a percentage of total memory bandwidth utilization. The apparatus further receives a hint from the processor circuitry when the bandwidth threshold is exceeded. The apparatus then applies a prioritization policy to the plurality of applications while the bandwidth threshold is exceeded.

### BACKGROUND

Some modern computing systems may only comprise a single channel of system memory, whereas traditionally, there have been two or more. This reduction in available bandwidth, coupled with increased demands on system memory from artificial intelligence (AI), neural processing units (NPUs), multi-endpoint (MEP) architectures, or integrated graphics (GFX), may cause poor user experiences in mixed workload conditions. In addition, some original equipment and design manufacturers ship systems from their factories with only one memory module (and therefore one channel) populated in their systems to reduce costs. This means many new personal computer (PC) users will experience single-channel system memory restrictions by default. Moreover, some users may also receive two-channel memory systems with limited memory bandwidth. As AI and graphical computing increase, the bandwidth of dual-channel systems will also be impacted. So, it is necessary to better manage how memory channel bandwidth is allocated. Therefore, an improved apparatus, method, and system for prioritizing applications based on memory bandwidth utilization is desired.

### BRIEF DESCRIPTION OF THE FIGURES

Some examples of apparatuses and/or methods will be described in the following by way of example only, and with reference to the accompanying figures, in which

FIG. 1 shows a block diagram of an example of an apparatus for prioritizing a plurality of applications based on memory bandwidth utilization; and

FIG. 2 shows a flowchart of a method for prioritizing a plurality of applications based on memory bandwidth utilization.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

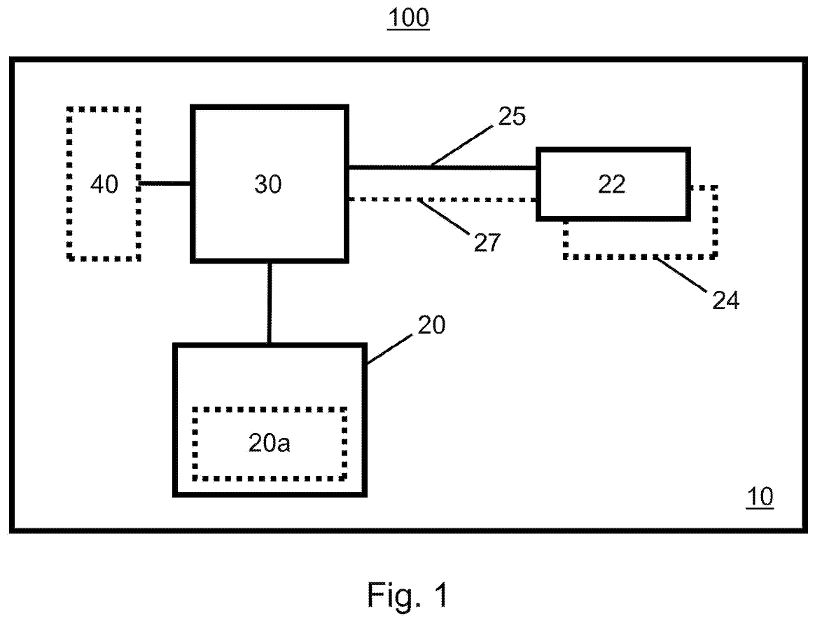

FIG. 1 shows a block diagram of an example of an apparatus 10 or device 10 comprising memory circuitry 20, machine-readable instructions 20a, and processor circuitry 30 to execute the machine-readable instructions. The apparatus 10 determines a bandwidth threshold. This threshold indicates a percentage of total memory bandwidth utilization and is based on a plurality of applications running on the apparatus 10.

The apparatus 10 is configured to receive a hint from the processor circuitry 30 when the bandwidth threshold is reached or exceeded. In response to this hint, the apparatus 10 may apply a prioritization policy to the plurality of applications currently in operation. This policy is actively enforced while the bandwidth threshold continues to be exceeded.

Performance monitoring counters within the hardware of a processor may determine the total system memory bandwidth utilization. This utilization monitoring, along with a programmable threshold value, may allow for a software consumable bit that can be triggered when the threshold value is crossed. When this event occurs, this hint can be passed to software that may then prioritize—through affinization and/or hardware resource exposure control—preferred applications and their system-on-a-chip (SoC) resources.

The apparatus combines the ability to comprehend system memory bandwidth utilization and manipulate system hardware resources via software affinity and control. Preferential resource allocation within the system may minimize the latency and bandwidth impacts to desired application responsiveness. This may be accomplished by coordinating several key pieces in the system.

Once determined, the apparatus 100 may provide the bandwidth threshold to the processor circuitry. The threshold may be read from memory, or it may be provided directly to a processor. Providing the threshold directly may allow for quicker detection of the threshold without complicated or latent off-processor memory accesses to read threshold.

Providing the bandwidth threshold may comprise writing the bandwidth threshold to a first register of the processor circuitry. When the bandwidth threshold is exceeded, a bit may be set in a second register of the processor circuitry. Receiving a hint may comprise being provided with, reading, or otherwise consuming this bit.

A register in the processor 30 may allow a programmable threshold value to be set as a percentage of total memory bandwidth. Another bit may be set when this value is crossed, indicating the threshold has been reached. This may facilitate a hint that software—for example, an application resource management software solution—could consume to begin or end an application optimization action.

A hint may be a software or hardware mechanism, directive, indication, or other form of communication between the processor and other system components. In hardware, it could be a signal or state that advises certain actions or configurations. A hint may also be implemented as a software consumable bit, which may be a bit, a set of bits, or a flag within a register or memory specifically intended to be read and acted upon by software.

A memory bandwidth threshold may be a predefined marker of data transfer rate on a channel 25, 27 coupled to a processor 30 and volatile memory 22, 24, for example, Random Access Memory (RAM). When this threshold is exceeded, certain predefined actions or adjustments in system performance or data prioritization may be triggered.

A prioritization policy or resource allocation prioritization may be a set of rules or algorithms a system uses to determine the order or preference in which tasks, processes, or data packets are handled. This policy dictates how resources are allocated and can be based on a range of factors such as urgency, importance, resource availability, or predefined criteria. A memory bandwidth threshold may be set at or indicate any percentage of total memory bandwidth utilization. For example, the threshold of total memory bandwidth utilization may be set to at least 75% (at least 15%, at least 50%, at least 85%, or at least 95%). Total memory bandwidth utilization on channel 25, 27 may be any amount. For example, a channel may support memory bandwidth up to 80 Gigabytes per second (GB/s; up to 100 GB/s, up to 200 GB/s, up to 500 GB/s, or up to 1 Terabyte per second).

A prioritization policy may be implemented by an application resource management software solution. It may be programmed to allocate resources to and prioritize processors for a previously determined application. These may be, for example, applications using integrated GFX, AI, MEP, or an end-user preference. Applying a policy may provide a better quality of service (QoS) and a better end-user experience than may otherwise be afforded if resources were being contended for.

Once the memory bandwidth threshold value returns to a number below the threshold bit programmed value, the application resource management software solution may retire the prioritization policy and return the system to normal operation.

The apparatus 10 may comprise a single memory channel 25 for communication with volatile memory 21, wherein the bandwidth threshold indicates the percentage of total memory bandwidth utilization on the single memory channel 25. Systems with single memory channels may require most or all of memory bandwidth to improve the performance of heavy bandwidth applications. For example, AI applications may require nearly 100% of bandwidth to improve response times. By prioritizing these applications when bandwidth utilization is high, these applications may finish quicker, allowing for both faster AI responses and for more normal bandwidth usage to resume quicker. However, dual-channel systems may also utilize and need the same prioritization. Some dual-channel systems ship with limited bandwidth. As AI, graphics, and other computing models become more complex and demanding, channel bandwidth limits may soon be reached without prioritizing applications, as discussed herein.

The bandwidth threshold may be one of a plurality of bandwidth thresholds provided to the processor circuitry. For example, a plurality of bandwidth thresholds may be set at 15%, 50%, and 75% of total memory bandwidth utilization. The prioritization policy may be one of a plurality of prioritization policies. Each bandwidth threshold may correspond to one of the plurality of prioritization policies. The apparatus may apply one of the plurality of prioritization policies while its corresponding bandwidth threshold is exceeded. For example, when a bandwidth threshold of 50% is reached, a prioritization policy for AI may be employed. Then, when a bandwidth threshold of 75% is reached, a prioritization policy for gaming may be employed.

The prioritization policy may be applied to a plurality of threads of the plurality of applications. Prioritization may be applied on a per-thread basis rather than on a per-application basis; this may be beneficial for applications that integrate high bandwidth features that would otherwise expect to receive lower prioritization. For example, when AI is integrated into a word processor, only the AI threads may be prioritized. A thread for prioritization may be a physics thread, a rendering thread, or an artificial intelligence thread. A single application may have multiple threads that may be treated differently than if they were separate applications. For example, a game that contains threads for rendering physics and AI for dialog may prioritize physics threads over AI threads when a bandwidth threshold is reached. However, a dedicated AI application, such as a smart home assistant, may take precedence over a game when a threshold is reached. This allows the prioritization policy to be tailored to various scenarios and granularities.

The prioritization policy may choose an appropriate core for each application of the plurality of applications. The policy may prioritize one or more applications to run on specific or appropriate hardware on the processor 30. This allows AI applications or threads to be directed to dedicated cores like NPUs, while graphical applications or threads can be directed to integrated GFX. More memory bandwidth may be freed up by directing applications to specific hardware than if the applications or threads were not specifically directed. For example, specific hardware that complements the application may finish its memory access quicker than more genderized or non-specific hardware. In another example, specialized cores like NPUs may have a dedicated cache for certain memory operations, freeing up bandwidth on a memory channel that is used for more general memory operations.

The prioritization policy may promote a primary set of applications of the plurality of applications for running on the processor circuitry over a remaining set of applications. Resource allocation and processor prioritization to a previously determined application may provide better QoS and a better end-user experience than may otherwise be afforded if resources were being contended for.

Determining the bandwidth threshold may be dynamic based on a workload of the apparatus. Using AI or machine learning, the apparatus 10 may learn appropriate thresholds based on tracked, learned, or real-time conditions. This may allow the prioritization of certain applications earlier under certain working conditions, for example, if the apparatus 10 predicts that the system will soon be bandwidth-constrained.

The prioritization policy may be determined by a user. Preset preferences or end-user-controlled preferences may be used to allocate the constrained memory bandwidth to provide the best end-user experience. Preset preferences may aim for the lowest latency AI response or better integrated GFX framerates. However, allowing users to determine which applications are prioritized when memory bandwidth is constrained may improve the end-user experience by promoting their desired set of applications over undesired applications. This may mean that when the bandwidth threshold is crossed, an application that would otherwise not be prioritized for bandwidth, such as a word processor, may still be prioritized if the user chooses. The user may also determine one or more bandwidth thresholds for one or more channels 25, 27.

The apparatus 10 may measure historical usage patterns and performance metrics of the plurality of applications. The apparatus may further determine a prioritization policy based on historical usage patterns and performance metrics. Performance monitoring counters built into a processor or processing circuitry may allow the apparatus to comprehend the current system status of memory bandwidth usage. This, along with software logging, means that trends can be tracked. These trends may be used to build or modify one or more prioritization policies.

A user may be provided with historical usage patterns and performance metrics of the plurality of applications, which may allow the user to better craft a personalized prioritization policy. The control mechanisms employed by the apparatus may also allow end-users or AI to best determine system experiences or responsiveness based on preferences. This may minimize the impact of limited memory bandwidth in a system, allowing for a better end-user experience on Intel systems.

The apparatus 10 may comprise a plurality of memory channels 25, 27 for communication with volatile memory 22. One or more bandwidth thresholds may indicate the percentage of total memory bandwidth utilization across the plurality of memory channels. For example, the bandwidth thresholds may be global for the entire available memory bandwidth. When a plurality of bandwidth thresholds are available, bandwidth thresholds may be set individually for each channel. This may be useful if the quality or bandwidth of each channel is not homogeneous. The user may optionally set these bandwidth thresholds.

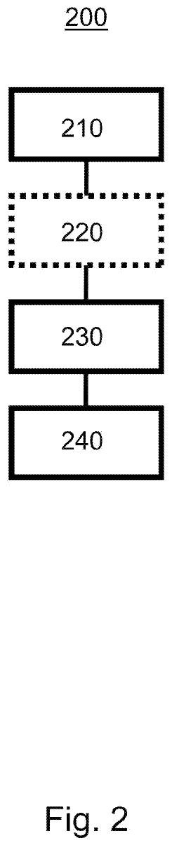

FIG. 1 further shows that the apparatus 10 comprises circuitry to provide the functionality of the apparatus 10. For example, the circuitry of the apparatus 10 may be configured to provide the functionality of the apparatus 10. For example, the apparatus 10 of FIG. 1 includes optional interface circuitry 40, processor circuitry 30, and memory circuitry 20. For example, the processor circuitry 30 may be coupled with the interface circuitry 40 and with the memory circuitry 20. For example, the processor circuitry 30 may provide the functionality of the apparatus, in conjunction with the interface circuitry 40 (for exchanging information, such as with other components inside or outside the computer system 100 comprising the apparatus 10 or device 10), the memory circuitry 20 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or be implemented by, the respective structural components of the apparatus 10. For example, the device 10 of FIG. 1 includes means for processing 30, which may correspond to or be implemented by the processor circuitry 30, means for communicating 40, which may correspond to or be implemented by the interface circuitry 40, (optional) means for storing information 20, which may correspond to or be implemented by the memory circuitry 20. In general, the functionality of the processor circuitry 30 or means for processing 30 may be implemented by the processor circuitry 30 or means for processing 30 executing machine-readable instructions. Accordingly, any feature ascribed to the processor circuitry 30 or means for processing 30 may be defined by one or more instructions of a plurality of machine-readable instructions. The apparatus 10 or device 10 may comprise the machine-readable instructions, e.g., within the memory circuitry 20, a storage circuitry (not shown), or a means for storing information 20. For example, the processor circuitry 30 or means for processing 30 may perform a method shown in the present disclosure, such as the method discussed in connection with FIG. 2.

The interface circuitry 40 or means for communicating 40 may correspond to one or more inputs and/or outputs for receiving and/or transmitting information, which may be in digital (bit) values according to a specified code, within a module, between modules or between modules of different entities. For example, the interface circuitry 40 or means for communicating 40 may comprise circuitry configured to receive and/or transmit information.

For example, the processor circuitry 30 or means for processing 30 may be implemented using one or more processing units, one or more processing devices, or any means for processing, such as a processor, a computer, or a programmable hardware component being operable with accordingly adapted software. In other words, the described function of the processor circuitry 30 or means for processing may as well be implemented in software, which is then executed on one or more programmable hardware components. Such hardware components may comprise a general-purpose processor, a Digital Signal Processor (DSP), a microcontroller, etc.

For example, the memory circuitry 20 or means for storing information 20 may be a volatile memory, e.g., random access memory, such as dynamic random-access memory (DRAM) or static random-access memory (SRAM).

FIG. 1 further shows system 100 comprising processor circuitry 30, volatile memory 22, 24, and a non-transitory, machine-readable medium 20 storing program code 20a. The processor circuitry 30 is coupled to the volatile memory 22,24 via a memory channel 25, 27. The program code 20a, when executed by the processor circuitry 30, enables the system 100 to determine a bandwidth threshold based on the plurality of applications running on the system 100, wherein the bandwidth threshold indicates a percentage of total memory bandwidth utilization on the memory channel 25, 27. The system 100 sets the bandwidth threshold in a register associated with the processor circuitry 30. The system 100 is further enabled to receive a hint from the processor circuitry 30 when the bandwidth threshold is exceeded. The system 100 may then apply a prioritization policy to the plurality of applications while the bandwidth threshold is exceeded.

The system 100 may use performance monitoring counters or capabilities for system memory bandwidth and software that consumes counter hints to manipulate system resources on a per-application basis.

The computer system 100 may be at least one of a client computer system, a server computer system, a rack server, a desktop computer system, a mobile computer system, a security gateway, and a router. The mobile device 100 may be one of a smartphone, tablet computer, wearable device, or mobile computer.

More details and optional aspects of the device of FIG. 1 may be described in connection with examples described below (e.g. FIG. 2).

FIG. 2 shows a flowchart of method 200 or a computer-implemented method for prioritizing a plurality of applications based on memory bandwidth utilization. The method 200 determines 210 a bandwidth threshold based on the plurality of applications, wherein the bandwidth threshold is a percentage of total memory bandwidth utilization. The method 200 further includes receiving 230 a hint from the processor circuitry when the bandwidth threshold is exceeded. The method 200 then includes applying 240 a prioritization policy to the plurality of applications while the bandwidth threshold is exceeded.

Optionally or alternatively, the method 200 may provide 220 the bandwidth threshold to processor circuitry. Optionally or alternatively, the method 200 may measure historical usage patterns and performance metrics of the plurality of applications. Optionally or alternatively, method 200 may determine the prioritization policy based on the historical usage patterns and performance metrics. Optionally or alternatively, method 200 may provide a user with historical usage patterns and performance metrics of the plurality of applications.

A non-transitory, machine-readable medium storing program code may, when the program code is executed by processor circuitry, a computer, or a programmable hardware component, cause the processor circuitry, the computer, or the programmable hardware component to perform the method 200.

More details and aspects of the concept for prioritizing a plurality of applications based on memory bandwidth utilization are mentioned in connection with the proposed concept or one or more examples described above (e.g. FIGS. 1 & 2) or below. The concept for prioritizing a plurality of applications may comprise one or more additional optional features corresponding to one or more aspects of the proposed concept or one or more examples described above or below.

An example (e.g. example 1) relates to an apparatus comprising memory circuitry, machine-readable instructions, and processor circuitry to execute the machine-readable instructions to determine a bandwidth threshold based on a plurality of applications running on the apparatus, wherein the bandwidth threshold indicates a percentage of total memory bandwidth utilization; provide the bandwidth threshold to the processor circuitry; receive a hint from the processor circuitry when the bandwidth threshold is exceeded; and apply a prioritization policy to the plurality of applications while the bandwidth threshold is exceeded.

Another example (e.g. example 2) relates to a previously described example (e.g. example 1), wherein the machine-readable instructions further comprise providing the bandwidth threshold to the processor circuitry.

Another example (e.g. example 3) relates to a previously described example (e.g. example 2), wherein providing the bandwidth threshold comprises writing the bandwidth threshold to a first register of the processor circuitry.

Another example (e.g. example 4) relates to a previously described example (e.g. one of the examples 1-3), wherein a bit is set in a second register of the processor circuitry when the bandwidth threshold is exceeded.

Another example (e.g. example 5) relates to a previously described example (e.g. one of the examples 1-4), wherein the apparatus comprises a single memory channel for communication with volatile memory, wherein the bandwidth threshold indicates the percentage of total memory bandwidth utilization on the single memory channel.

Another example (e.g. example 6) relates to a previously described example (e.g. one of the examples 1-5), wherein the bandwidth threshold is one of a plurality of bandwidth thresholds determined, wherein the prioritization policy is one of a plurality of prioritization policies, wherein each of the plurality of bandwidth thresholds corresponds to one of the plurality of prioritization policies, wherein one of the plurality of prioritization policies is applied while its corresponding bandwidth threshold is exceeded.

Another example (e.g. example 7) relates to a previously described example (e.g. one of the examples 1-6), further comprising applying the prioritization policy to a plurality of threads of the plurality of applications.

Another example (e.g. example 8) relates to a previously described example (e.g. example 7), wherein a thread of the plurality of threads is one of a physics thread, a rendering thread, and an artificial intelligence thread.

Another example (e.g. example 9) relates to a previously described example (e.g. one of the examples 1-8), wherein the prioritization policy chooses an appropriate core for each application of the plurality of applications.

Another example (e.g. example 10) relates to a previously described example (e.g. one of the examples 1-9), wherein the prioritization policy promotes a primary set of applications of the plurality of applications for running on the processor circuitry over a remaining set of applications.

Another example (e.g. example 11) relates to a previously described example (e.g. one of the examples 1-10), wherein determining the bandwidth threshold is dynamic based on a workload of the apparatus.

Another example (e.g. example 12) relates to a previously described example (e.g. one of the examples 1-11), wherein the prioritization policy is determined by a user.

Another example (e.g. example 13) relates to a previously described example (e.g. one of the examples 1-12), further comprising providing historical usage patterns and performance metrics of the plurality of applications to a user.

Another example (e.g. example 14) relates to a previously described example (e.g. one of the examples 1-13), further comprising measuring historical usage patterns and performance metrics of the plurality of applications, further comprising determining the prioritization policy based on the historical usage patterns and performance metrics.

Another example (e.g. example 15) relates to a previously described example (e.g. one of the examples 1-14), wherein the apparatus comprises a plurality of memory channels for communication with volatile memory, wherein the bandwidth threshold indicates the percentage of total memory bandwidth utilization across the plurality of memory channels.

An example (e.g. example 16) relates to a method for prioritizing a plurality of applications on a system based on memory bandwidth utilization, the method comprising determining a bandwidth threshold based on the plurality of applications, wherein the bandwidth threshold is a percentage of total memory bandwidth utilization; receiving a hint from the processor circuitry when the bandwidth threshold is exceeded; and applying a prioritization policy to the plurality of applications while the bandwidth threshold is exceeded.

Another example (e.g. example 17) relates to a previously described example (e.g. example 16), further comprising providing the bandwidth threshold to processor circuitry.

Another example (e.g. example 18) relates to a previously described example (e.g. example 16), wherein providing the bandwidth threshold comprises writing the bandwidth threshold to a first register of the processor circuitry.

Another example (e.g. example 19) relates to a previously described example (e.g. one of the examples 16-18), wherein a bit is set in a second register of the processor circuitry when the bandwidth threshold is exceeded.

Another example (e.g. example 20) relates to a previously described example (e.g. one of the examples 16-19), wherein the bandwidth threshold indicates the percentage of total memory bandwidth utilization on a single memory channel for communication with volatile memory.

Another example (e.g. example 21) relates to a previously described example (e.g. one of the examples 16-20), wherein the bandwidth threshold is one of a plurality of bandwidth thresholds determined, wherein the prioritization policy is one of a plurality of prioritization policies, wherein each of the plurality of bandwidth thresholds corresponds to one of the plurality of prioritization policies, wherein one of the plurality of prioritization policies is applied while its corresponding bandwidth threshold is exceeded.

Another example (e.g. example 22) relates to a previously described example (e.g. one of the examples 16-21), further comprising applying the prioritization policy to a plurality of threads of the plurality of applications.

Another example (e.g. example 23) relates to a previously described example (e.g. example 22), wherein a thread of the plurality of threads is one of a physics thread, a rendering thread, and an artificial intelligence thread.

Another example (e.g. example 24) relates to a previously described example (e.g. one of the examples 16-23), wherein the prioritization policy chooses an appropriate core for each application of the plurality of applications.

Another example (e.g. example 25) relates to a previously described example (e.g. one of the examples 16-24), wherein the prioritization policy promotes a primary set of applications of the plurality of applications for running on the processor circuitry over a remaining set of applications.

Another example (e.g. example 26) relates to a previously described example (e.g. one of the examples 16-25), wherein determining the bandwidth threshold is dynamic based on a workload of the system.

Another example (e.g. example 27) relates to a previously described example (e.g. one of the examples 16-26), wherein the prioritization policy is determined by a user.

Another example (e.g. example 28) relates to a previously described example (e.g. one of the examples 16-27), further comprising providing historical usage patterns and performance metrics of the plurality of applications to a user.

Another example (e.g. example 29) relates to a previously described example (e.g. one of the examples 16-28), further comprising measuring historical usage patterns and performance metrics of the plurality of applications, further comprising determining the prioritization policy based on the historical usage patterns and performance metrics.

Another example (e.g. example 30) relates to a previously described example (e.g. one of the examples 16-29), wherein the bandwidth threshold indicates the percentage of total memory bandwidth utilization across a plurality of memory channels for communication with volatile memory.

An example (e.g. example 31) relates to a non-transitory, machine-readable medium storing program code that, when the program code is executed by processor circuitry, a computer, or a programmable hardware component, causes the processor circuitry, the computer, or the programmable hardware component to perform the performing the method of a previously described example (e.g. one of the examples 16-30).

An example (e.g. example 32) relates to a system comprising: processor circuitry; volatile memory, wherein the processor circuitry is coupled to the volatile memory via a memory channel; a non-transitory, machine-readable medium storing program code that, when executed by the processor circuitry, enable the system to: determine a bandwidth threshold based on the plurality of applications running on the system, wherein the bandwidth threshold indicates a percentage of total memory bandwidth utilization on the memory channel; set the bandwidth threshold in a register associated with the processor circuitry; receive a hint from the processor circuitry when the bandwidth threshold is exceeded; and apply a prioritization policy to the plurality of applications while the bandwidth threshold is exceeded.

Another example (e.g. example 33) relates to a previously described example (e.g. example 32), wherein the system is configured to perform the method of the previously described example (e.g. one of the examples 16-2830

An example (e.g. example 34) is a system comprising an apparatus, computer-readable medium, or circuitry for performing a method of a previously described example (e.g. one of the examples 16-30).

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g. machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. An apparatus comprising memory circuitry, machine-readable instructions, and processor circuitry to execute the machine-readable instructions to:
determine a bandwidth threshold based on a plurality of applications running on the apparatus, wherein the bandwidth threshold indicates a percentage of total memory bandwidth utilization;
receive a hint from the processor circuitry when the bandwidth threshold is exceeded; and
apply a prioritization policy to the plurality of applications while the bandwidth threshold is exceeded.

2. The apparatus of claim 1, wherein the machine-readable instructions further comprise providing the bandwidth threshold to the processor circuitry.

3. The apparatus of claim 2, wherein providing the bandwidth threshold comprises writing the bandwidth threshold to a first register of the processor circuitry.

4. The apparatus of claim 1, wherein a bit is set in a second register of the processor circuitry when the bandwidth threshold is exceeded.

5. The apparatus of claim 1, wherein the apparatus comprises a single memory channel for communication with volatile memory, wherein the bandwidth threshold indicates the percentage of total memory bandwidth utilization on the single memory channel.

6. The apparatus of claim 1, wherein the bandwidth threshold is one of a plurality of bandwidth thresholds determined, wherein the prioritization policy is one of a plurality of prioritization policies, wherein each of the plurality of bandwidth thresholds corresponds to one of the plurality of prioritization policies, wherein one of the plurality of prioritization policies is applied while its corresponding bandwidth threshold is exceeded.

7. The apparatus of claim 1, further comprising applying the prioritization policy to a plurality of threads of the plurality of applications.

8. The apparatus of claim 7, wherein a thread of the plurality of threads is one of:
a physics thread,
a rendering thread, and
an artificial intelligence thread.

9. The apparatus of claim 1, wherein the prioritization policy chooses an appropriate core for each application of the plurality of applications.

10. The apparatus of claim 1, wherein the prioritization policy promotes a primary set of applications of the plurality of applications for running on the processor circuitry over a remaining set of applications.

11. The apparatus of claim 1, wherein determining the bandwidth threshold is dynamic based on a workload of the apparatus.

12. The apparatus of claim 1, wherein the prioritization policy is determined by a user.

13. The apparatus of claim 12, further comprising providing historical usage patterns and performance metrics of the plurality of applications to the user.

14. The apparatus of claim 1, further comprising measuring historical usage patterns and performance metrics of the plurality of applications, further comprising determining the prioritization policy based on the historical usage patterns and performance metrics.

15. The apparatus of claim 1, wherein the apparatus comprises a plurality of memory channels for communication with volatile memory, wherein the bandwidth threshold indicates the percentage of total memory bandwidth utilization across the plurality of memory channels.

16. A method for prioritizing a plurality of applications based on memory bandwidth utilization, the method comprising:
determining a bandwidth threshold based on the plurality of applications, wherein the bandwidth threshold is a percentage of total memory bandwidth utilization;
receiving a hint from processor circuitry when the bandwidth threshold is exceeded; and
applying a prioritization policy to the plurality of applications while the bandwidth threshold is exceeded.

17. A non-transitory, machine-readable medium storing program code that, when the program code is executed by processor circuitry, a computer, or a programmable hardware component, causes the processor circuitry, the computer, or the programmable hardware component to perform the method of claim 16.

18. A system comprising:
processor circuitry,
volatile memory, wherein the processor circuitry is coupled to the volatile memory via a memory channel; and
a non-transitory, machine-readable medium storing program code that, when executed by the processor circuitry, enables the system to:
determine a bandwidth threshold based on the plurality of applications running on the system, wherein the bandwidth threshold indicates a percentage of total memory bandwidth utilization on the memory channel;
set the bandwidth threshold in a register associated with the processor circuitry;
receive a hint from the processor circuitry when the bandwidth threshold is exceeded; and
apply a prioritization policy to the plurality of applications while the bandwidth threshold is exceeded.
